(19) United States
(12) Patent Application Publication
(10) Pub. No.: US 2014/0010412 A1
(43) Pub. Date: Jan. 9, 2014

(54) Video Image Capture and Identification of Vehicles

(71) Applicant: Life on Show Limited, Langstone (GB)

(72) Inventor: Adam James Price, Langstone (GB)

(73) Assignee: Life on Show Limited, Langstone (GB)

(21) Appl. No.: 14/022,780

(22) Filed: Sep. 10, 2013

Related U.S. Application Data
(63) Continuation of application No. PCT/GB2012/000232, filed on Mar. 9, 2012.

(30) Foreign Application Priority Data
Mar. 11, 2011 (GB) 1104168.8
Mar. 16, 2011 (GB) 1104435.1

(51) Int. Cl. G06K 9/00

(52) U.S. Cl. CPC G06K 9/00785
USPC 382/105

(57) ABSTRACT

A method and apparatus for capturing, sorting and subsequently viewing an orbital image record of a vehicle, the method comprising the steps, in any suitable order, of using imaging means (11,15) to capture an orbital moving image record of the vehicle in various orientations relative to the imaging means, storing and sorting the captured orbital image record for each vehicle by reference to a unique identifier for that vehicle externally visible to the imaging means during image capture, such as the vehicle licence or registration number, to provide a continuous image record unique to the vehicle, and thereafter selectively displaying (12) orbital images of the vehicle.

### TECHNICAL FIELD

This invention relates to the field of video capture and, in particular, video image capture of vehicles for presentation via a web site.

### BACKGROUND OF THE INVENTION

Vehicle dealerships are known to use web sites to display information relating to vehicles which they are offering for sale. The aim is to attract potential customers by enabling them to view the vehicles in stock. The information may include text and/or digital photographs describing and showing each vehicle, although it has become increasingly common to provide video clips.

In US2009/0160930 there is shown a method for recording digital images of motor vehicles from various angles whilst mounted on a vehicle turntable. Each recorded image is then stored in a digital data memory in conjunction with a unique vehicle identifier, such as the vehicle chassis number, before the recording process commences, so that at the end of the recording session the frames recorded are attributed to the unique identifier chosen before another such session commences involving a different vehicle so that, for each vehicle, the captured data is separately matched via a unique identifier. However, a disadvantage of this particular system is that all recorded frames have to be transmitted to an image processing computer 15 before the computer 5 for controlling the video camera 8 is again available for use with another recording sequence for another vehicle, leading to delays in the system.

Typically, such capture systems incorporate media content for each vehicle into web pages which can then be displayed via the potential customer's web browser. The process of capturing the content typically involves driving a vehicle onto a turntable via an on/off ramp and then photographing or videoing the vehicle as the platform of the turntable rotates.

Typically, the content is streaming media content and the vehicle is filmed through an entire 360 degree orbital rotation of the turntable in order to provide an orbital image record such that the customer can view the vehicle from all angles.

This process can be laborious and time consuming, not least because dealers often prefer each video to begin with the vehicle shown from a standard (default) angle i.e. a predetermined orbital commencement position. This view is deemed to show the vehicle in a favourable position and thus make it more attractive to the potential buyer. Therefore, at the start of each capture session (i.e. when a vehicle has been driven up the ramp on to the turntable to be photographed and/or filmed) the turntable must be rotated such that the vehicle is in the correct position relative to the camera. This typically involves a technician operating the turntable by means of push buttons to manoeuvre the vehicle into the correct starting position.

Once the vehicle is in the default commencement position, the image capture process can be initiated. The technician must initiate rotation of the turntable as well as switch on the necessary lighting equipment and start recording via the camera. During the image capture process, the vehicle is rotated by means of the turntable until the desired amount of data has been recorded and stored (e.g. a video of the vehicle during one full rotation of the platform).

Once the technician believes that the desired amount of data has been recorded, he brings the turntable to a halt and concludes the video/image capture by stopping the camera. He does this by mechanical means (e.g. pressing buttons or switches to operate the camera/turntable). Lighting used to illuminate the vehicle during filming must then be powered off or down once filming is complete.

The vehicle can then be removed from the turntable. However, the turntable is unlikely to have come to a halt with the vehicle in alignment with the on/off ramp and so the platform must be rotated such that the vehicle is in the correct position for being driven off the turntable. Again, this requires technician effort and time to manoeuvre the turntable.

The media content (typically streaming video content) is then processed into packets and uploaded onto a server for viewing via the dealer's web site.

Thus, the customer is able to browse and view the dealer's stock of vehicles without having to physically visit the showroom. Clearly, such a facility can be an extremely valuable marketing tool for the dealer.

However, a significant amount of technician time and effort is required to perform the process of positioning the vehicle at the start of each capture session, synchronising the rotation of the turntable with the operation of the camera, halting the rotation and image capture, switching necessary lighting equipment on and/or off at the appropriate times, and positioning of the vehicle ready for removal from the turntable.

It is thus an object of the invention to automate and streamline the above process so as to minimise the time and effort required from the technician in manipulating the mechanical devices, in particular in relation to positioning of the vehicle on the turntable and operation of the camera. The less technician time/effort required, the more vehicles can be filmed per day. This in turn provides cost saving benefits.

### SUMMARY

According to the invention there is provided a method for capturing, sorting and subsequently viewing an orbital image record of a vehicle, the method comprising the steps, in any suitable order, of using imaging means to capture an orbital moving image record of the vehicle in various orientations relative to the imaging means, storing and sorting the captured orbital image record for each vehicle by reference to a unique identifier for that vehicle externally visible to the imaging means during image capture, such as the vehicle licence or registration number, to provide a continuous image record unique to the vehicle, and thereafter selectively displaying orbital images of the vehicle.

Conveniently, the step of sorting the captured orbital image record for each vehicle by reference to a unique identifier for that vehicle involves the step of including validating algorithms by which multiple readings of the vehicle's unique identifier are extracted at varying angular positions around the vehicle, leading to a plurality of results and increasing confidence levels as to their accuracy being achieved, such as by matching, for example, 12 number plate readings in the orbital image record to verify that the image content throughout the record relates to only that vehicle.

The confidence level in the number recognition may be further increased by its associated algorithm rejecting or downgrading numbers perceived to be below a given size, this being a particularly useful feature where the method is used away from a vehicle turntable, such as by using orbital image capture in a car park where the image recognition hardware and/or software may inadvertently capture images of other vehicles as well as the target vehicle and where it can be reasonably assumed that their relative distance from the imaging means results in smaller letters and/or numbers being recorded as compared to those on the target vehicle.

Conveniently, extraction and encoding of the unique vehicle identifier is independent of operation of the imaging means such that on completion of obtaining an orbital image record for a vehicle a subsequent orbital image record for another vehicle may be recorded while the extraction and encoding process for the previous vehicle is still ongoing.

### BRIEF DESCRIPTION OF THE DRAWINGS

An embodiment of the present invention will now be described, by way of example only, and with reference to the accompanying drawings, in which:

FIG. 1 shows a flowchart illustrating a high level overview of a system in accordance with the invention.

FIG. 2 shows a more detailed flowchart of a system in accordance with an embodiment of the invention.

FIG. 3 shows a screen shot of sample log-in screen in accordance with an embodiment of the invention.

FIG. 4 shows a screen shot of an initial dialogue screen in accordance with an embodiment of the invention.

FIG. 5 shows a screen shot of a settings dialogue screen in accordance with an embodiment of the invention.

FIG. 6 shows a screen shot of a main dialogue screen in accordance with an embodiment of the invention, including adjacent exterior and interior views of a vehicle as viewed by exterior and interior cameras respectively, and a ‘record’ button.

FIGS. 7 and 8 show screen shots of the main dialogue screen of FIG. 6 after the ‘record’ button has been clicked.

FIG. 9 shows a screen shot of a dialogue screen in accordance with an embodiment of the invention, the screen indicating that the present capture session is complete and providing a ‘start’ button to facilitate commencement of another capture session.

FIG. 10 shows a screen shot of a license verification screen in accordance with an embodiment of the invention.

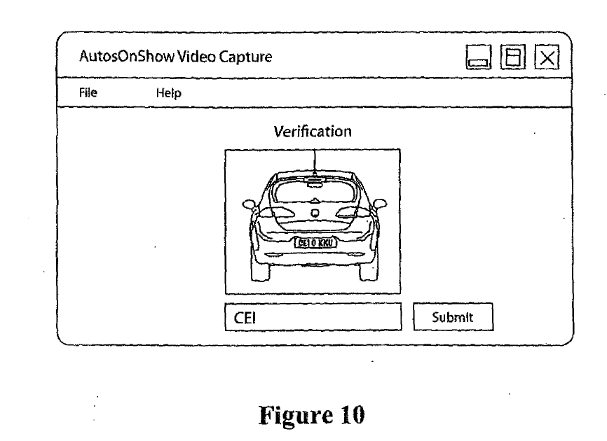

### DETAILED DESCRIPTION

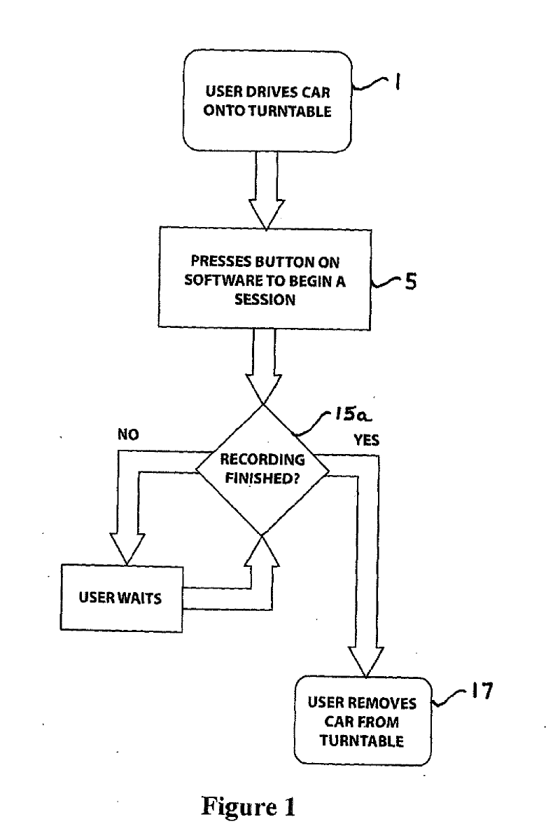

Turning to FIG. 1, the aim of the present invention is to provide a more efficient means of generating and delivering media content relating to vehicles by minimising the input required by video camera and/or turntable operators. The invention comprises the use of a computer processor executing software which controls a turntable, interior and/or exterior lighting devices and a camera in an automated fashion. In the illustrative embodiment described herein, a video camera is mounted outside the vehicle so as to capture moving images of the exterior of the vehicle. In another embodiment, the camera may be hand-held by a technician walking around the vehicle. Alternatively or additionally, a camera may be mounted on a rotating internal rig inside the vehicle to capture images of the vehicle interior. The intention either way is to provide an orbital video image record of the vehicle.

Thus, a very general overview of the process of the invention is shown in FIG. 1, in which a car is driven up a ramp onto a turntable and the user instructs the software component of the system to perform a media capture session (i.e. only one instruction or input is required to cause the software to manoeuvre the vehicle into the correct starting position relative to the camera, start rotation, lighting and recording, conclude rotation, lighting and recording at the appropriate point in time, and position the vehicle for removal via the ramp).

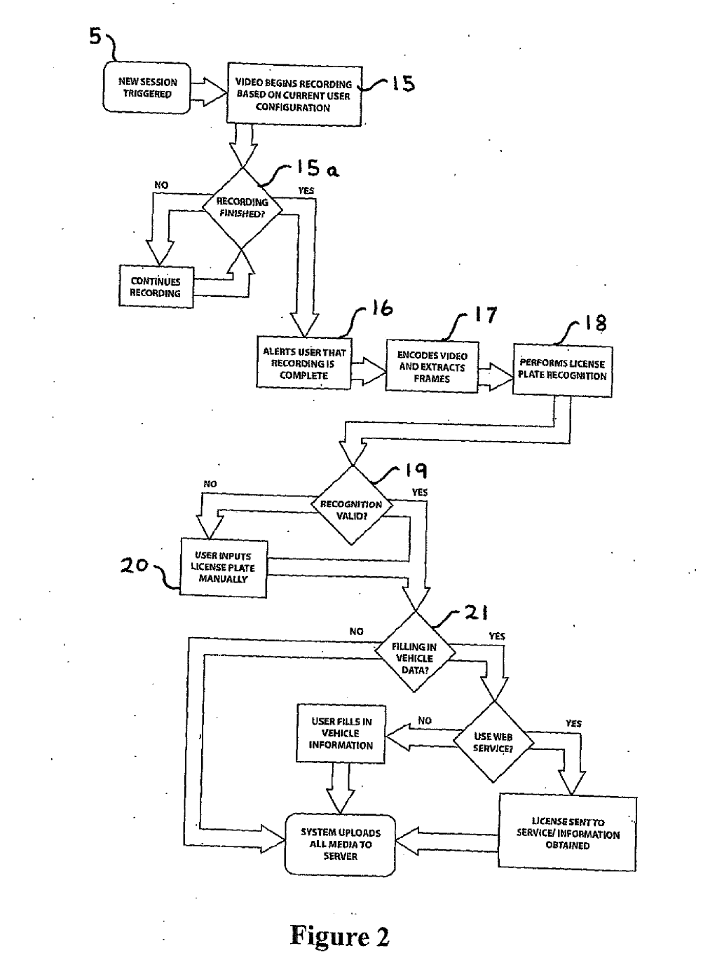

FIG. 2 shows an expanded view of this process, including the process stages which may be performed after recording has finished.

In use, a technician (i.e. user) drives a vehicle which is to be recorded up a ramp onto the rotatable platform of a turntable (shown as step 1, FIG. 1). The technician can then exit the vehicle and move to a console or screen in communication with the other system components comprising the invention.

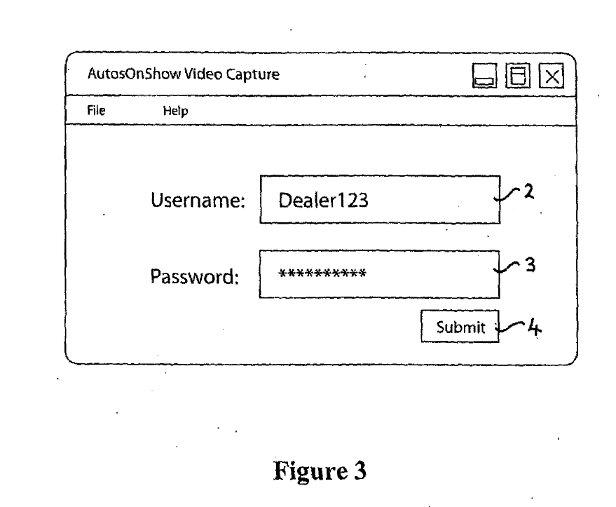

The system comprises a graphical user interface which is designed to be as simplistic and minimalistic as possible. As only authorised (licensed) users are permitted access to the system, the technician is first presented with a log in screen, an illustration of which is shown in FIG. 3. The technician must supply a usemame 2 and password 3 which, when the submit button 4 is clicked, are recognised by the system as belonging to an authorised user.

Once the technician has successfully logged in, he is permitted access to those system features or components for which he is authorised. As will be explained in more detail below, the system may comprise a variety of features and a given user may choose to subscribe to all or only some of those features. Thus, upon successful log-in, the system checks the technician's privilege status and enables access to the subscribed system components.

A variety of settings may exist for each system component to which the technician has authorised access, including settings (i.e. parameters) for configuring the user's interaction with the core system (i.e. the video capture component). The user's settings are stored in a file on the system, and may be accessed (for viewing and/or changing) by the user via an option provided in the graphical user interface. In the illustrative screen shots of the Figures, the settings may be accessed via a drop-down menu provided on a menu bar.

Other settings may include a choice of video formats which may be used, or which camera is to be selected for use from a plurality of devices. Other settings may also be included and the invention is not intended to be limited in this regard. For example, settings related to the lighting (illumination) of the vehicle may be included.

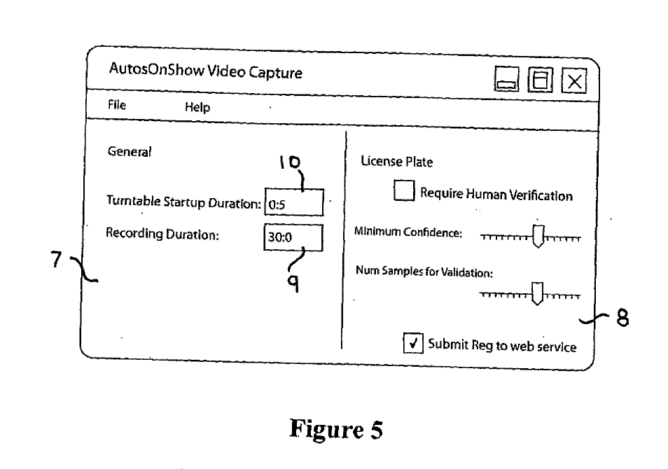

FIG. 5 shows an example of a screen displaying a user's session settings. In this illustration, the left hand side of the screen 7 displays the general parameters governing the user's video capture session. The user can change these parameters according to his needs or preferences. For example, the length of video recording to be made per vehicle can be altered by varying the value in box 9. The amount of time for which the turntable is to rotate at start up (to be explained in more detail below) can also be altered.

In FIG. 5, the right hand side of the screen 8 displays settings relating to an optional system feature which shall be discussed below.

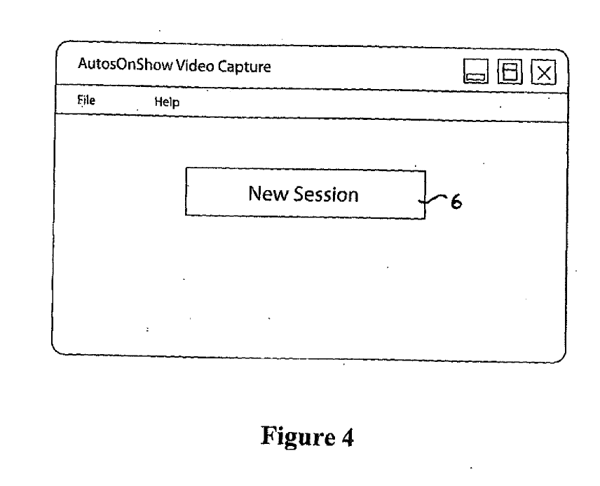

Thus, upon successful log in, the user's settings file is retrieved and loaded into memory so as to configure the interaction with the system during the session. The video capture session will begin once the user clicks the ‘new session’ button 6 on the initial dialogue screen (shown as step 5 in FIGS. 1 and 4).

At this point, an initial check is performed on the camera(s) included in the system to ensure that the cameras are functional and ready for use. A connection is established between the system software and a receiver such as a flexiPanel Bluetooth receiver to enable ‘start’ and ‘stop’ commands to be sent to the turntable to begin/conclude rotation. This connection is initiated at the start of the session and will remain open until the session is concluded by the user.

Now that the user has successfully logged in, the session settings have been loaded, the Bluetooth connection is established with the turntable, and the capture session begins.

Prior to starting the recording, the system may control the lighting equipment by switching it on or turning the illumination up to a desired level such the vehicle is appropriately illuminated during the capture session.

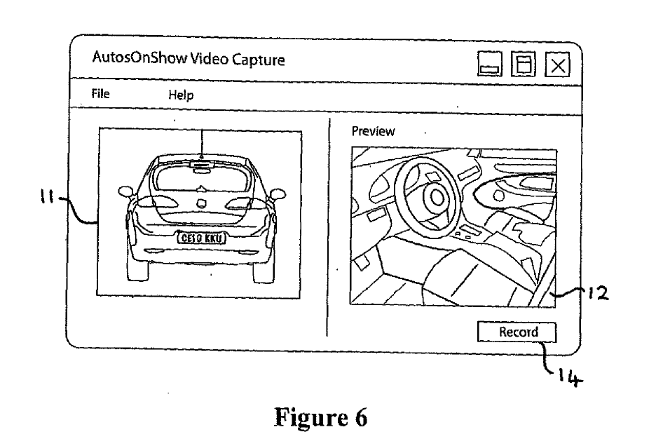

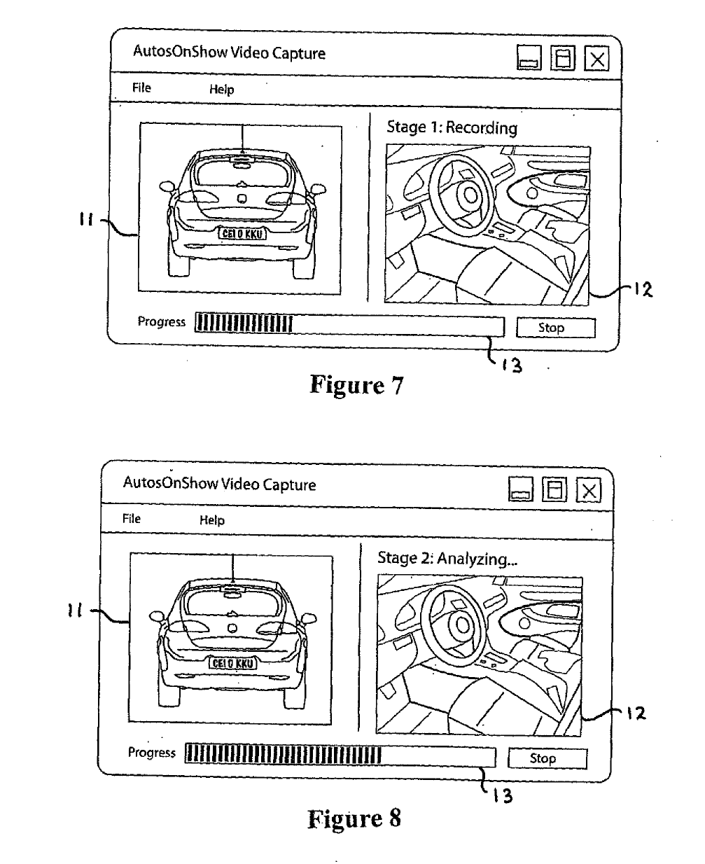

The technician is presented with a main dialogue screen as shown in FIGS. 6, 7 and 8. The dialogue screen shows a preview of the exterior vehicle on the turntable as viewed by the camera 11. If the optional interior camera is also being used because the user has subscribed to this system feature, the view from the interior camera will also be presented on the screen 12. Upon clicking the ‘Record’ button 14, video capture begins. The preview remains on the screen for the duration of the capture session and is updated in real time.

The software instructs the turntable to commence rotation via a Bluetooth connection. Once the turntable rotation has reached an optimal speed (as determined by the user's settings) the system instructs the selected camera(s) to begin recording 15. The recording continues for the length of time specified by the user's settings, and a progress bar 13 shows the user that the recording process is underway, and also provides an indication of the length of recording left to complete. The recording is stored locally on the system. A textual message (e.g. ‘Stage 1: Recording’ or ‘Stage 2: Analysing’ may be presented to the user to indicate which process stage the system is currently performing. If an error is encountered, the recording is halted and an error message is displayed.

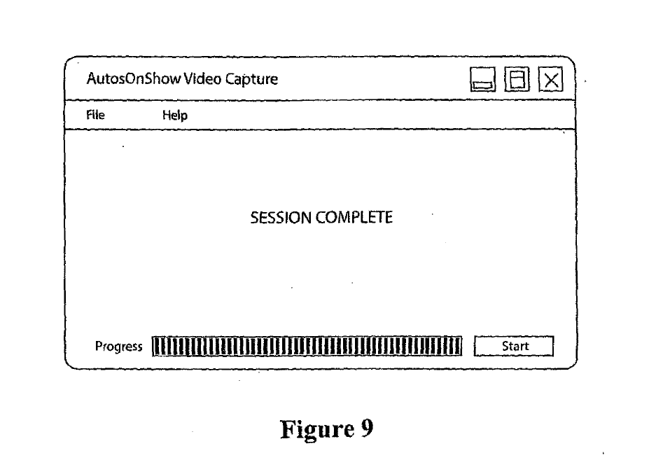

Once the specified length of video has been recorded the camera stops recording 15a, the user is alerted 16 to this event via a ‘Session complete’ screen (FIG. 9). The vehicle may be driven off the turntable at this point in time. The system may also power off (or dim) the lighting equipment after filming has finished. The point in the capture session at which the system adjusts the lighting levels may also vary.

Once the recording stage has been completed, the processing stage begins. The stored video is encoded 17 ready for upload to a web server by an uploader module. Extraction of still images may also be performed during the processing stage and may use conventional number recognition equipment, such as that available at www.ndi-rs.com. Nevertheless, an important difference between the system described in US2009/0160930 and the subject invention is the ability of the latter to be more time efficient in that as soon as the video camera stops recording the target vehicle the software carries out the number plate recognition extraction, the encoding and subsequent uploading of images and the extracted unique identifier for that vehicle, typically the registration number, although it will be understood that other unique identifiers may be used on the outside of the target vehicle in the absence of a number plate, such as a randomly generated number with sufficient digits to make accidental duplication unlikely.

It should also be noted that, upon initial installation of the invented system at a physical site, the system will need to be calibrated ready for first use. As explained above, car dealers typically prefer the video clips to begin with the vehicle positioned at a particular, predetermined angle relative to the camera. At each site, however, the turntable and camera may be positioned slightly differently and the direction from which the vehicle approaches the turntable may differ from one site to another. Thus, upon installation, the turntable may be operated manually to rotate the turntable until the vehicle is in the correct initial (default) alignment. The length of rotation time is recorded within the system such that at the start of each session the system ‘knows’ that prior to recording, the turntable must be rotated through a specific angle to manoeuvre the vehicle into the correct starting position.

Once this degree of required rotation is known, each session automatically begins with rotation of the turntable through to the required position without the need for further input, manoeuvring or manual manipulation of the turntable by the technician. Once in the correct starting position, the system automatically causes the turntable to pause for a pre-determined and stored amount of time prior to commencement of recording and rotation.

The system therefore provides the ability to extract the vehicle's registration details directly from the recording 18 and after the vehicle registration number has been automatically extracted by the system from the captured video, the registration details are stored and passed to the uploader module of the system for upload to the media server along with the other (video/image) content.

Number recognition is conducted prior to the encoding and is performed in real time on the raw captured video (since this provides the clearest input data for the recognition algorithm).

As image recognition is a difficult field of research, and detection of letters and symbols is not currently 100% reliable, the invention preferably incorporates validation algorithms to increase the reliability of the recognition system.

Traditionally, license plate recognition is performed on a single source image and the success of the operation is dependent upon multiple factors such as the resolution of the image, image format and image dimension, the angle of the license plate relative to the camera, distance of plate from lens and font use on license; and external factors such as level of lighting, cleanliness of plate etc.

Within the context of the invention, the recognition process is optimised due to the controlled environment in which the vehicle is filmed. However, errors may still arise. For example, a false-positive recognition may result in an incorrect registration number.

Thus, one or more metrics may be utilized by the recognition algorithm. The accuracy of the recognition analysis may be assessed and improved by performing a software-implemented check of each individual digit after recognition has been performed on a number plate. If, for example, the software decides that a digit could potentially have been confused or mistaken for another digit, a low ‘confidence level’ may be applied to the recognition result, which could be flagged to the user by the system.

Once flagged, the user may be prompted to visually check that the license plate determined by the recognition software corresponds to that of the vehicle. An example of such checks and the associated user prompts is shown in the right hand side of the screen 8 of FIG. 5.

In another embodiment, multiple still views of the vehicle, such as 12, may be taken at varying angles during the recording process, of which some, say 4, will include the vehicle number plate. The number of sample attempts may be specified (stored) in the system configuration file as determined by the user. Upon completion of a number of attempted recognitions, a plurality of results and confidence levels are analysed by the system and amalgamated into a ‘global’ confidence level. Should this level be above a predefined metric level, confidence that the registration matches the vehicle registration increases.

In the event that a successful recognition is not achieved 19, the user may be provided with the option of inputting the data manually 20.

Upon automated or manual input of the registration number, other data relating to the vehicle may be inputted 21. If the option has been enabled, a web service call can be made to retrieve data from external sources for that vehicle registration automatically. The entire set of data (vehicle details, image/video content and registration details) may then be uploaded to the media server by the uploader module for access by potential customers.

Thus, the invention provides an automated solution to capturing orbital video or image data of a vehicle, by means of an at least partially computer-implemented system which controls and directs the hardware devices (turntable, cameras etc) such that a human operator does not need to manually coordinate and synchronise the start-up and end points of the capture process. The system can also ensure that the vehicle is put into the correct initial position in relation to the camera without the need for user interaction, thus saving considerable time and effort and, in turn, money due to increased throughput of vehicles. Thus, the automated solution provided by the invention provides a more efficient alternative to the known approach.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method for capturing, sorting and subsequently viewing an orbital image record of a vehicle, the method comprising the steps, in any suitable order, of using imaging means (11,15) to capture an orbital moving image record of the vehicle in various orientations relative to the imaging means, storing and sorting the captured orbital image record for each vehicle by reference to a unique identifier for that vehicle externally visible to the imaging means during image capture, such as the vehicle licence or registration number, to provide a continuous image record unique to the vehicle, and thereafter selectively displaying (12) orbital images of the vehicle.

2. A method according to claim 1 wherein the step of sorting the captured orbital image record for each vehicle by reference to a unique identifier for that vehicle involves the step of including validating algorithms by which multiple readings of the vehicle's unique identifier are extracted at varying angular positions around the vehicle, leading to a plurality of results and increasing confidence levels as to their accuracy being achieved.

3. A method according to claim 2 wherein the confidence level in the number recognition is further increased by its associated algorithm rejecting or downgrading numbers perceived to be below a given size.

4. A method according to claim 1 wherein conveniently, extraction and encoding of the unique vehicle identifier is independent of operation of the imaging means such that on completion of obtaining an orbital image record for a vehicle a subsequent orbital image record for another vehicle may be recorded while the extraction and encoding process for the previous vehicle is still ongoing.

5. Apparatus for carrying out a method according to claim 1 including imaging means (11,15) arranged to capture an orbital image record of a vehicle in various orbital orientations, means to extract from the imaging means a unique identifier visible on the outside of the vehicle, such as the vehicle registration number, storage means for storing data obtained from the image capture and extraction process and means for subsequently uploading the data to a display (12).

6. Apparatus according to claim 5 wherein the extraction of the unique identifier involves the use of a plurality of algorithms by which selected levels of confidence of accuracy of the extracted data may be achieved.
